(19) United States
(12) Patent Application Publication
(10) Pub. No.: US 2010/0169817 A1
(43) Pub. Date: Jul. 1, 2010

(54) METHOD AND APPARATUS FOR CONTEXT ENHANCED WIRELESS DISCOVERY

(76) Inventors: Roy Want, Los Altos, CA (US); Kenton Lyons, Santa Clara, CA (US); Trevor Pering, San Francisco, CA (US); Shivani A. Sud, Santa Clara, CA (US); Barbara Rosario, Berkeley, CA (US)

Correspondence Address: KACVINSKY LLC;C/O CPA Global, P.O. BOX 52050, MINNEAPOLIS, MN, 55402, US

(21) Appl. No.: 12/347,174

(22) Filed: Dec. 31, 2008

(51) Int. Cl. G06F 3/048

(52) U.S. Cl. 715/772

(57) ABSTRACT

A system, apparatus, method and article for context enhanced wireless discovery are described. The apparatus may include a discovery module to receive status information for one or more target devices, the status information comprising physical characteristics of the one or more target devices. The apparatus may also include a composition manager to generate a graphical user interface including icons representing the one or more target devices, the icons including graphical representations of the status information. Other embodiments are described and claimed.

### BACKGROUND

Utilizing wireless connectivity as a means for communicating between computing devices is becoming increasingly popular. Communication connections can be established between computing devices to share a variety of information, including resources or data available to any number of computing devices. As the number of computing devices that are wirelessly discoverable continues to increase, however, problems develop regarding accurately identifying what devices are available for connection, what resources are available on these devices, and where the devices are located, for example. Consequently, there exists a substantial need for a method and apparatus for context enhanced wireless discovery.

### BRIEF DESCRIPTION OF THE DRAWINGS

FIG. 1 illustrates one embodiment of a system.

FIG. 2 illustrates one embodiment of a graphical user interface.

FIG. 3 illustrates one embodiment of a logic diagram.

FIG. 4 illustrates a second embodiment of a system.

### DETAILED DESCRIPTION

The embodiments may generally relate to a method and apparatus for context enhanced wireless discovery. One embodiment relates to a mobile computing device comprising a discovery module to receive status information for one or more target devices. In some embodiments, the status information comprises physical characteristics of the one or more target devices. The mobile computing device may also include a composition manager to generate a graphical user interface including augmented graphical icons, graphs, or text, organized to represent the status information in various embodiments. The icons may include graphical representations of the status information. Other embodiments are described and claimed.

Users of computing devices with wireless communication capabilities, hereinafter referred to as mobile computing devices, may desire to wirelessly connect to other mobile computing devices to transfer data, share resources or otherwise directly communicate. The processing and storage capabilities of mobile computing devices is ever increasing, resulting in strains being placed on the devices due to the limited size of their screens and keyboards, and the limited number of applications currently available for mobile computing devices. As a result, users may desire to wirelessly utilize hardware, applications, data or any other suitable information from another computing device using their own mobile computing device.

For example, a user may walk into a conference room carrying their own mobile computing device. The conference room may contain any number of computing devices with wireless capabilities with which the user may desire to connect their device. For example, the user may wish to connect their mobile computing device to the mobile computing device of another user, a display on the wall of the conference room, a laptop computer on the conference room table, or any other suitable computing device. In this example, it may be difficult for the user to identify and connect to the correct device.

Prior solutions to this problem involve, for example, a name-based network discovery process, where a user may be required to select the name of a desired target device to initiate a connection. This may be problematic in areas where many wireless devices are available or the target device has a non-descriptive name that is difficult to identify. Additionally, this approach may require that the user know any security information associated with the desired target device. Therefore, in various embodiments, a method and apparatus for context enhanced wireless discovery are described herein that rely on physical characteristics detected by sensors associated with target devices to aid in the identification and connection process. Other embodiments are described and claimed.

Numerous specific details are set forth to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

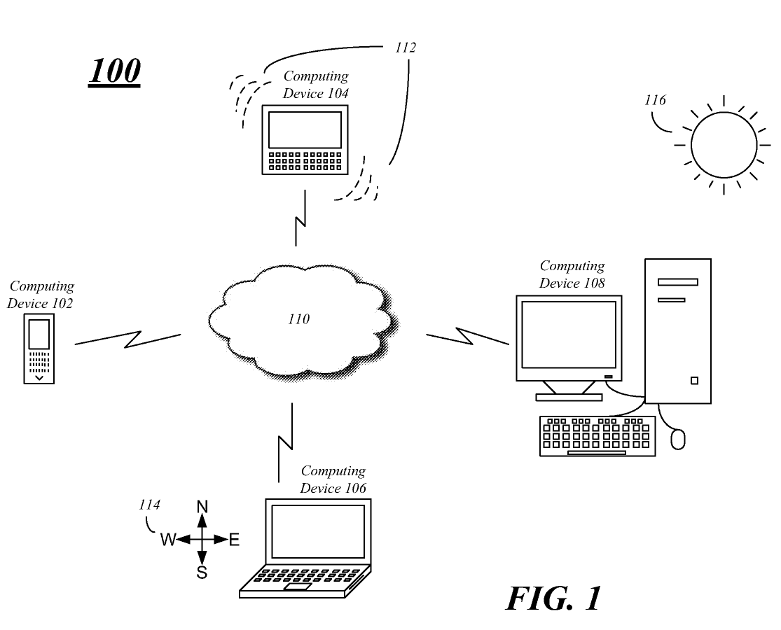

FIG. 1 illustrates one embodiment of a system. FIG. 1 illustrates a system 100. System 100 may be representative of the one or more embodiments described herein. System 100 includes computing devices 102, 104, 106 and 108 and network 110. Network 110 may comprise any wireless communication network suitable for wirelessly communicating information. The computing devices 102, 104, 106 and 108 may comprise any computing device capable of wireless communication. For example, computing device 102 may comprise a smart-phone, computing device 104 may comprise a mobile internet device (MID), computing device 106 may comprise a laptop computer and computing device 108 may comprise a desktop computer. Although FIG. 1 may show a limited number of computing devices by way of example, it can be appreciated that a greater or a fewer number of devices may be employed for a given implementation.

In various embodiments, it may be desirable to establish a wireless connection between two or more of the computing devices 102, 104, 106 or 108. For example, computing device 102 (e.g. the source device) may be wirelessly connected to any of computing devices 104, 106 or 108 (e.g. target devices). The connection process begins with a discovery process. For example, wireless layer-2 discovery, typically used by WiFi and ultra-wideband (UWB), could be utilized as the discovery protocol. During the discovery process, the source device 102 receives name information for the one or more target devices 104, 106 and 108. However, in situations where many target devices are available, it may be difficult to select the desired target device based solely on name information. Consequently, information in addition to name information may be provided to the source device in some embodiments.

In various embodiments, the source device 102 may include a discovery module to receive status information for one or more of the target devices 104, 106 and 108. In some embodiments, the status information may comprise physical characteristics of the one or more target devices. For example, one or more of the target devices may have one or more sensors associated with the target device or integrated within the target device. In some embodiments, one or more of the target devices may include one or more of accelerometers, compasses or light sensors, for example. While a limited number and type of sensors are described by way of example, it should be understood that any type or number of sensors could be associated with or integrated within a target device and still fall within the described embodiments.

In various embodiments, the sensor associated with the target device may comprise an accelerometer. The accelerometer may comprise a device for measuring acceleration and gravity induced reaction forces. For example, the accelerometer may be configured to detect movement associated with the target device. Computing device 104 may include an accelerometer in some embodiments. The accelerometer may be configured to detect movement associated with computing device 104. For example, if a user were to shake mobile computing device 104, as illustrated by movement lines 112, the accelerometer may be configured to detect this movement and use this information as status information to be relayed during the discovery process.

The sensor associated with the target device may comprise a compass in some embodiments. The compass may comprise an instrument for determining direction relative to the earth's magnetic poles. For example, the compass may be configured to detect a direction that the target device is facing. In some embodiments, computing device 106 may be associated with a compass. The directional information received from the compass could be used by computing device 106 as status information. For example, as shown in FIG. 1, the display of computing device 106 is pointed south as illustrated by directional information 114. This information may be communicated during the discovery process.

In some embodiments, the sensor associated with the target device may comprise a light sensor. The light sensor may comprise a photosensor, photodetector, photoresistor or other suitable sensor for detecting changes in light intensity. For example, computing device 108 may be associated with a light sensor capable of providing status information indicating that computing device 108 is near a light source, such as light source 116. Other embodiments are described and claimed.

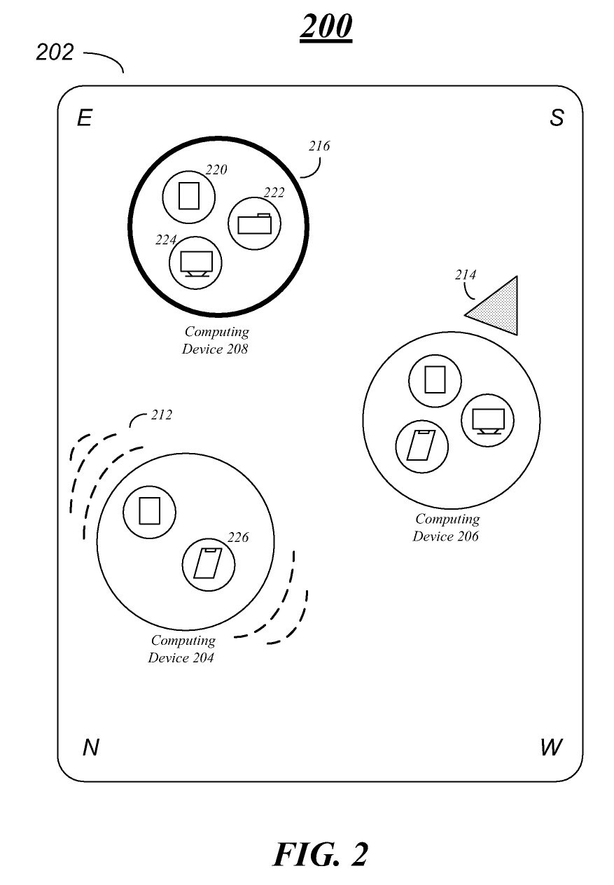

The source device 102 may also include a composition manager to generate a graphical user interface which may include augmented graphical icons, graphs, or text, organized to represent the status information in some embodiments. In various embodiments, the icons may include graphical representations of the status information, including information provided by the one or more sensors associated with the target devices. The graphical user interface, icons and graphical representations of the status information are discussed in more detail with reference to FIG. 2.

FIG. 2 illustrates a graphical user interface (GUI) 200. As shown, FIG. 2 includes a GUI 202 which may be representative of a GUI displayed on a display of mobile computing device 102, for example. GUI 202 includes directional indicators N, S, E and W, device icons 204, 206 and 208, status icons 212, 214 and 216 and service icons 220, 222, 224 and 226. Although GUI 202 illustrates a limited number of icons by way of example, it can be appreciated that a greater or fewer number of icons may be employed for a given implementation.

In various embodiments, device icons 204, 206 and 208 may comprise graphical representations of computing devices that are wirelessly discoverable (e.g. target devices). For example, GUI 202 may be displayed on a display of device 102, indicating that target devices 104, 106 and 108 are currently wirelessly discoverable by device 102. As illustrated in FIG. 2, the device icons 204, 206 and 208 may include name information (e.g. “Computing Device 204” etc.). Additionally, the device icons 204, 206 and 208 may be associated with status icons 212, 214 and 216 that comprise graphical representations of the status information for the target devices.

In various embodiments, the device icons 204, 206, 208 or the graphical representations of the status information (e.g. status icons 212, 214 and 216) may be configured to dynamically change within the GUI 202 in response to changes in the physical characteristics of the one or more target devices. The changes may occur in real time or as close to real time as possible given the computing restraints of the system. The changes should be reflected accurately enough in GUI 202 to assist a user of the computing device with identification of target devices as changes to the status of the target device are occurring.

For example, computing device 104 may be associated with an accelerometer and the physical characteristic associated with computing device 104 may comprise movement information detected by the accelerometer. When computing device 104 is moved, for example, if the user of the computing device 104 shakes the device, an icon representing the target device (e.g. device icon 204) or the graphical representations of the status information for the target device (e.g. status icon 212) may dynamically change within the graphical user interface 202 in response to the movement information. For example, when the user shakes or moves device 104, movement lines may appear in real time in GUI 202 to illustrate that device 104 is currently being moved. This may assist a user of computing device 102 in correctly identifying computing device 104.

In some embodiments the target device, such as target device 106, may be associated with a compass and the physical characteristic measured and communicated during the discovery process may comprise position information associated with the target device. For example, as shown in FIG. 1, target device 206 includes a compass indicating that the screen of the device is facing south. In various embodiments, the icon representing the target device (e.g. device icon 206) or the graphical representations of the status information for the target device (e.g. status icon 214) may dynamically change position within the graphical user interface in response to changes in position of the mobile computing device 102 or the target device 106. In this manner, a user of mobile computing device 102 may be able to accurately identify a device that is facing in a desired direction or positioned in a desired location. For example, in a room with target devices positioned on each of four walls, the inclusion of position information indicated by status icon 214 may allow the user to quickly identify where devices are positioned in relation to the users position indicated by the directional information N, S, E and W in the GUI 202. More precise positioning and ranging can also be derived from RF Received Signal Strength Indication (RSSI) measurements or Time-Of-Flight (TOF) measurements for RF signals between devices in some embodiments. Further, in various embodiments, RF transmission in combination with ultrasonic transmission can be used to calculate the relative distance between devices based on the speed difference of sound in air versus. the propagation speed of EM waves through space (e.g. 1 cm resolutions over 5 m are readily achievable).

The target device, such as target device 108, may be associated with a light sensor and the physical characteristic measured by the sensor may comprise an amount of light detected by the light sensor in various embodiments. In some embodiments, an icon representing the target device (e.g. device icon 208) or the graphical representations of the status information (e.g. status icon 216) for the target device may dynamically change in responses to changes in the amount of light detected by the light sensor. For example, if computing device 208 were close to a window, the status icon 216 may appear brighter than the other icons that may be further away from the window. In some embodiments, a user may be able to shine a laser pointer, or flash light, on a target device to assist in identifying the desired device.

Furthermore, many other sensors can be used to determine the state of the device in addition to position, movement and light. For example, sensors measuring, barometric pressure (e.g. indicating altitude), temperature (e.g. indicating proximity to a heatsource, such as a fireplace or radiator), capacitive sensors (e.g. indicating being held in one/two hands), microphone (e.g. indicating sound level), NFC (e.g. indicating proximity to an RFID tag or an NFC reader), chemical, gas, bio, or radiation sensors (e.g. indicating proximity to a chemical, biological or radioactive source) or any other suitable sensor may be used and still fall within the described embodiments. Other embodiments are described and claimed.

In additional to the status information illustrated by status icons 212, 214 and 216, GUI 202 may also include service information illustrated by service icons 220, 222, 224 and 226. In various embodiments, the service icons 220, 222, 224 and 226 may comprise graphical representations of services, data or information that are available from the associated target devices. For example, target device 208 may include documents 220, storage 222 or display 224 as items or services that are available following the establishment of a wireless connection with target device 208. Additionally, target devices 204 and 206 may also include clipboard 226 as an available service. While a limited number of services and service icons are shown by way of example, it should be understood that any number of services or services icons could be used and still fall within the described embodiments.

Furthermore, while FIG. 2 illustrates icons having a certain shape and configuration, it should be understood that any shape or configuration could be used for the various icons. In some embodiments, the device icons 204, 206 and 208 may comprise icons that look like the devices they are illustrating. For example, device icon 204 may appear as a graphical representation of a mobile computing device in GUI 202. Other embodiments are described and claimed.

In various embodiments, the source device, such as device 102, may also include a connection module to establish a wireless connection between the mobile computing device 102 and one or more of the target devices 104, 106 and 108. In some embodiments, the connection is established based on a selection signal received from the composition manager, the selection signal generated based on a user interaction with the graphical user interface 202. For example, a user may select an icon representing the target device in GUI 202, and the connection with the target device may be initiated based on the user selection. Further, the status provided by a sensor on the source device or target device may be used to generate the connection selection signal. For example, a physical action or state at one device may be used as a metaphor for connection with another device. For example, the compass information on the source device might be used to select the target device based on the direction the source device is pointing. If the source device is now shaken or other movement information is detected, this action may be interpreted as a connection request with the device it is currently pointing at. Similar metaphors can be used to disconnect from devices in some embodiments. For example, turning the source device upside-down and shaking the device may break the wireless connections with another device (similar to the erase metaphor used with the popular children's toy Etch-a-sketch).

In various embodiments, each mobile computing device may include various physical and/or logical components for communicating information which may be implemented as hardware components (e.g., computing devices, processors, logic devices), executable computer program instructions (e.g., firmware, software) to be executed by various hardware components, or any combination thereof, as desired for a given set of design parameters or performance constraints. Exemplary mobile computing devices with which connections may be established include a personal computer (PC), desktop PC, notebook PC, laptop computer, mobile computing device, smart phone, personal digital assistant (PDA), mobile telephone, mobile internet device (MID), combination mobile telephone/PDA, video device, television (TV) device, digital TV (DTV) device, high-definition TV (HDTV) device, media player device, gaming device, messaging device, or any other suitable communications device in accordance with the described embodiments.

The mobile computing devices may form part of a wired communications system, a wireless communications system, or a combination of both. For example, the mobile computing devices may be arranged to communicate information over one or more types of wired communication links such as a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The mobile computing devices may be arranged to communicate information over one or more types of wireless communication links such as a radio channel, satellite channel, television channel, broadcast channel infrared channel, radio-frequency (RF) channel, Wireless Fidelity (WiFi) channel, a portion of the RF spectrum, and/or one or more licensed or license-free frequency bands. In wireless implementations, the mobile computing devices may comprise one more interfaces and/or components for wireless communication such as one or more transmitters, receivers, transceivers, amplifiers, filters, control logic, wireless network interface cards (WNICs), antennas, and so forth. Although certain embodiments may be illustrated using a particular communications media by way of example, it may be appreciated that the described embodiments may be implemented using various communication media and accompanying technology.

Examples of systems and devices in which embodiments described herein can be incorporated comprise wireless local area network (WLAN) systems, wireless metropolitan area network (WMAN) systems, wireless personal area networks (WPAN), wide area networks (WAN), cellular telephone systems, radio networks, computers, and wireless communication devices, among others. Those skilled in the art will appreciate, based on the description provided herein, that the embodiments may be used in other systems and/or devices.

Embodiments of systems and devices described herein may comply or operate in accordance with a multitude of wireless standards. For example, a system and associated nodes may comply or communicate in accordance with one or more wireless protocols, which may be defined by one or more protocol standards as promulgated by a standards organization, such as the Internet Engineering Task Force (IETF), International Telecommunications Union (ITU), the Institute of Electrical and Electronics Engineers (IEEE), and so forth. In the context of a WLAN system, the nodes may comply or communicate in accordance with various protocols, such as the IEEE 802.11 series of protocols (e.g., wireless fidelity or WiFi). In the context of a WMAN system, the nodes may comply or communicate in accordance with the IEEE 802.16 series of protocols such as the Worldwide Interoperability for Microwave Access (WiMAX), for example. Those skilled in the art will appreciate that WiMAX is a standards-based wireless technology to provide high-throughput broadband connections over long distances (long range). WiMAX can be used for a number of applications, including “last mile” wireless broadband connections, hotspots, cellular backhaul, and high-speed enterprise connectivity for business. In the context of a personal area network (PAN), the nodes may comply or communicate in accordance with the IEEE 802.15 series of protocols otherwise known as Bluetooth, for example. In the context of a MAN, the nodes may comply or communicate in accordance with the IEEE 802.20 series of protocols, for example. For mobility across multiple networks, the nodes may comply or communicate in accordance with the IEEE 802.21 series of protocols, for example. In other embodiments, the system and nodes may comply with or operate in accordance with various WMAN mobile broadband wireless access (MBWA) systems, protocols, and standards, for example. The embodiments, however, are not limited in this context.

Embodiments of systems and devices described herein may comply or operate in accordance with a multitude of wireless technologies and access standards. Examples of wireless technologies and standards may comprise cellular networks (e.g., Global System for Mobile communications or GSM), Universal Mobile Telecommunications System (UTS), High-Speed Downlink Packet Access (HSDPA), Broadband Radio Access Networks (BRAN), General Packet Radio Service (GPRS), 3.sup.rd Generation Partnership Project (3GPP), and Global Positioning System (GPS); and Ultra Wide Band (UWB), Code Division Multiple Access (CDMA), CDMA 2000, Wideband Code-Division Multiple Access (W-CDMA), Enhanced General Packet Radio Service (EGPRS), among others. Systems and devices in accordance with various embodiments may be arranged to support multiple heterogeneous wireless devices to communicate over these wireless communication networks. The embodiments, however, are not limited in this context.

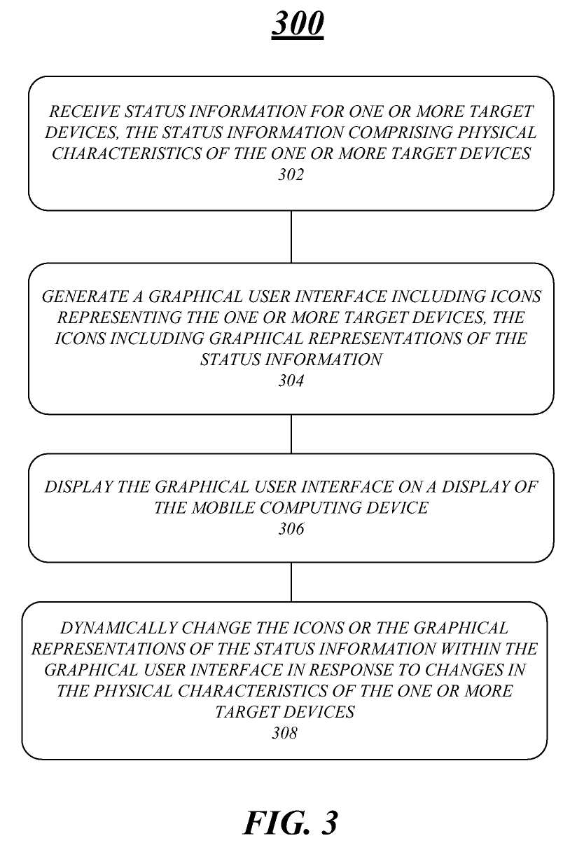

FIG. 3 illustrates one embodiment of a logic flow. FIG. 3 illustrates a logic flow 300. Logic flow 300 may be representative of the operations executed by one or more embodiments described herein. In some embodiments, a discovery process may be initiated to identify available target devices. As shown in logic flow 300, status information for one or more target devices may be received at 302. For example, mobile computing device 102 may receive status information for one or more of target devices 104, 106 and 108, for example. In various embodiments, the status information may comprise physical characteristics of the one or more target devices. The physical characteristics may be measured or detected by sensors associated with the target devices.

At 304, a graphical user interface including icons representing the one or more target devices may be generated wherein the icons include graphical representations of the status information. As illustrated in FIG. 2, GUI 202 includes device icons 204, 206 and 208 representing target devices 104, 106 and 108, and status icons 212, 214 and 216 graphically representing the status information for target devices. At 306, the graphical user interface may be displayed on a display of the mobile computing device. For example, GUI 202 may be displayed on a display of mobile computing device 102.

The icons or the graphical representations of the status information may be dynamically changed within the graphical user interface in response to changes in the physical characteristics of the one or more target devices. For example, status icons 212, 214 and 216 may be dynamically changed within GUI 202 to represent changes that occur with respect to target devices 104, 106 and 108.

In various embodiments, a wireless connection may be established between the mobile computing device and one or more of the target devices based on a selection of an icon representing the one or more target device. In some embodiments, for example, a user may select an icon representing a target device using GUI 202, and a connection with the target device may be initiated based on the selection. Other embodiments are described and claimed.

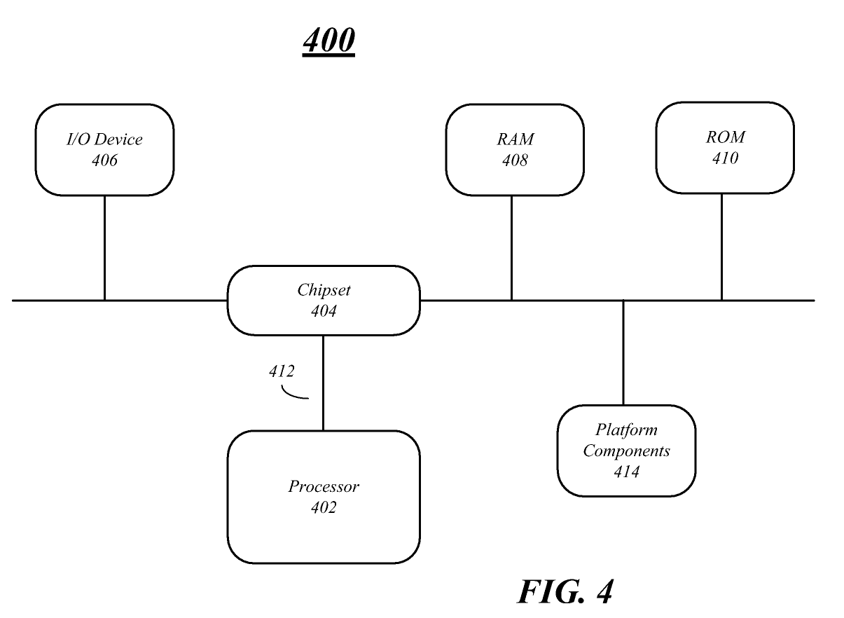

FIG. 4 is a diagram of an exemplary system embodiment. In particular, FIG. 4 is a diagram showing a system 400, which may include various elements and may represent any of the above described mobile computing devices, for example. For instance, FIG. 4 shows that system 400 may include a processor 402, a chipset 404, an input/output (I/O) device 406, a random access memory (RAM) (such as dynamic RAM (DRAM)) 408, and a read only memory (ROM) 410, and various platform components 414 (e.g., a heat sink, DTM system, cooling system, housing, vents, and so forth). These elements may be implemented in hardware, software, firmware, or any combination thereof. The embodiments, however, are not limited to these elements.

In particular, the platform components 414 may include a cooling system implementing various DTM techniques. The cooling system may be sized for the system 400, and may include any cooling elements designed to perform heat dissipation, such as heat pipes, heat links, heat transfers, heat spreaders, vents, fans, blowers, and liquid-based coolants.

As shown in FIG. 4, I/O device 406, RAM 408, and ROM 410 are coupled to processor 402 by way of chipset 404. Chipset 404 may be coupled to processor 402 by a bus 412. Accordingly, bus 412 may include multiple lines.

Processor 402 may be a central processing unit comprising one or more processor cores (102-1-m). The processor 402 may include any type of processing unit, such as, for example, CPU, multi-processing unit, a reduced instruction set computer (RISC), a processor that have a pipeline, a complex instruction set computer (CISC), digital signal processor (DSP), and so forth.

Processor 402 may operate at different performance levels. Accordingly, processor 402 may enter into various operational states, such as one or more active mode P-states. Thus, processor 402 may include features described above with reference to FIGS. 1-3. For instance, processor 402 may include the elements of any of the above described mobile computing devices, among others.

Although not shown, the system 400 may include various interface circuits, such as an Ethernet interface and/or a Universal Serial Bus (USB) interface, and/or the like. In some exemplary embodiments, the I/O device 406 may comprise one or more input devices connected to interface circuits for entering data and commands into the system 400. For example, the input devices may include a keyboard, mouse, touch screen, track pad, track ball, isopoint, a voice recognition system, camera, microphone, touchscreen display, biometric device and/or the like. Similarly, the I/O device 406 may comprise one or more output devices connected to the interface circuits for outputting information to an operator. For example, the output devices may include one or more displays, printers, speakers, and/or other output devices, if desired. For example, one of the output devices may be a display. The display may be a cathode ray tube (CRTs), liquid crystal displays (LCDs), or any other type of display.

The system 400 may also have a wired or wireless network interface to exchange data with other devices via a connection to a network. The network connection may be any type of network connection, such as an Ethernet connection, digital subscriber line (DSL), telephone line, coaxial cable, etc. The network may be any type of network, such as the Internet, a telephone network, a cable network, a wireless network, a packet-switched network, a circuit-switched network, and/or the like.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a storage medium, a computer-readable medium or an article of manufacture which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It should be understood that embodiments may be used in a variety of applications. Although the embodiments are not limited in this respect, certain embodiments may be used in conjunction with many electronic devices, such as a personal computer, a desktop computer, a mobile computer, a laptop computer, a notebook computer, a tablet computer, a server computer, a network, a Personal Digital Assistant (PDA) device, a wireless communication station, a wireless communication device, a cellular telephone, a mobile telephone, a wireless telephone, a PDA device or the like.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a discovery module to receive status information for one or more target devices, the status information comprising physical characteristics of the one or more target devices; and
a composition manager to generate a graphical user interface including augmented graphical icons, graphs, or text, organized to represent the status information.

2. The apparatus of claim 1, wherein the icons, graphs or text dynamically change within the graphical user interface in response to changes in the physical characteristics of the one or more target devices; and
wherein the status information is received and dynamically updated during a discovery process.

3. The apparatus of claim 1, wherein the physical characteristic comprises movement information associated with a target device, and an icon representing the target device or the graphical representations of the status information for the target device dynamically changes within the graphical user interface in response to the movement information.

4. The apparatus of claim 3, wherein the movement information is measured by an accelerometer associated with the target device.

5. The apparatus of claim 1, wherein the physical characteristic comprises position information associated with a target device, and an icon representing the target device or the graphical representations of the status information for the target device dynamically changes position within the graphical user interface in response to changes in position of a source device or the target device.

6. The apparatus of claim 5, wherein the position information is measured by a compass associated with the target device or the source device.

7. The apparatus of claim 1, wherein the physical characteristic comprises an amount of light detected by a light sensor associated with a target device, and an icon representing the target device or the graphical representations of the status information for the target device dynamically changes in responses to changes in the amount of light detected by the light sensor.

8. The apparatus of claim 1, further comprising:
a connection module to establish a wireless connection between a source device and one or more of the target devices, wherein the connection is established based on a selection signal received from the composition manager, the selection signal generated based on a user interaction with the graphical user interface.

9. The apparatus of claim 1, wherein the physical characteristic of the target device comprises one or more of movement information, position information, an amount of light detected by a light sensor, radio frequency received signal strength indication (RF RSSI) information, time-of-flight (TOF) information, barometric pressure information, temperature information, audio information, chemical information, gas information, bio information or radiation information.

10. A method, comprising:
receiving status information for one or more target devices, the status information comprising physical characteristics of the one or more target devices;
generating a graphical user interface including augmented graphical icons, graphs, or text, organized to represent the status information;
displaying the graphical user interface on a display of a source device; and
dynamically changing the icons or the graphical user interface in response to changes in the physical characteristics of the one or more target devices.

11. The method of claim 10, further comprising:
initiating a discovery process to identify target devices; and
establishing a wireless connection between the source device and one or more of the target devices based on a selection of an icon, graph or text representing one or more target device or based on the received status information for one or more target device or status information for source device.

12. The method of claim 10, wherein the physical characteristic comprises movement information measured by an accelerometer associated with a target device, and an icon representing the target device or the graphical representations of the status information for the target device dynamically changes within the graphical user interface in response to the movement information.

13. The method of claim 10, wherein the physical characteristic comprises position information measured by a compass associated with a target device, and an icon representing the target device or the graphical representations of the status information for the target device dynamically changes position within the graphical user interface in response to changes in position of the source device or the target device.

14. The method of claim 10, wherein the physical characteristic comprises an amount of light detected by a light sensor associated with a target device, and an icon representing the target device or the graphical representations of the status information for the target device dynamically changes in responses to changes in the amount of light detected by the light sensor.

15. The method of claim 10, wherein the physical characteristic of the target device comprises one or more of movement information, position information, an amount of light detected by a light sensor, radio frequency received signal strength indication (RF RSSI) information, time-of-flight (TOF) information, barometric pressure information, temperature information, audio information, chemical information, gas information, bio information or radiation information.
